(19) United States
(12) Patent Application Publication
(10) Pub. No.: US 2026/0298019 A1
(43) Pub. Date: Oct. 1, 2026

(54) Sliding Fire Door

(71) Applicant: Daifuku Co., Ltd., Osaka-shi (JP)

(72) Inventors: Takafumi Yamazaki, Hinocho (JP); Marika Saito, Hinocho (JP)

(21) Appl. No.: 19/576,099

(22) Filed: Mar. 24, 2026

(30) Foreign Application Priority Data
Mar. 25, 2025 (JP) 2025-049915

(51) Int. Cl. E06B 5/16; E06B 3/46

(52) U.S. Cl. CPC E06B 5/164; E06B 3/46

(57) ABSTRACT

A fire door attached to a wall body having an opening includes a door body and a guide mechanism that guides the door body in a sliding direction along the wall body. A portion of the door body that is disposed on a sliding direction first side relative to the opening when in an open position and overlaps with a wall surface in a view in a wall-orthogonal direction is a door body overlapping portion. An elastic fire-resistant member includes a fixing portion fixed to the door body overlapping portion and a contact portion formed in one piece with the fixing portion. The contact portion extends along a width direction of the door body overlapping portion and protrudes toward a wall-orthogonal direction first side relative to the door body.

### CROSS-REFERENCE TO RELATED APPLICATION

This application claims priority to Japanese Patent Application No. 2025-049915 filed Mar 25, 2025, the disclosure of which is hereby incorporated by reference in its entirety.

### BACKGROUND OF THE INVENTION

### 1. Field of the Invention

The present invention relates to a sliding fire door.

### 2. Description of Related Art

For example, JP 2018-204229A discloses a technology related to a sliding fire door. In the following description of the background art, reference signs in parentheses refer to those in JP 2018-204229A.

The sliding fire door of JP 2018-204229A includes an opening frame portion (7) attached to a wall body (2) having an opening (1), a door body (8), and a guide mechanism (9). The guide mechanism (9) guides the movement of the door body (8) in a sliding direction (Y). The door body (8) slides from an open position where the opening (1) is open, to a closed position where the opening (1) is closed. The door body (8) includes a first opposing surface (F3) opposing the wall body (2). The opening frame portion (7) also includes a second opposing surface (F1) that opposes the first opposing surface (F3) of the door body (8) in the closed position. The guide mechanism (9) is configured to move the first opposing surface (F3) closer to the second opposing surface (F1) as the door body (8) moves from the open position to the closed position.

In the sliding fire door of JP 2018-204229A, the door body moves closer to the wall body as it moves from the open position to the closed position. This reduces the gap between the door body and the wall body, improving the ability of the door body to close the opening. On the other hand, with such sliding fire doors, it is difficult to improve the ability of the door body to close the opening, and there is room for improvement in this regard.

### SUMMARY OF THE INVENTION

In view of the forgoing, it is desirable to realize a sliding fire door that can easily improve the ability to close the opening.

The sliding fire door according to the present disclosure is a sliding fire door to be attached to a wall body having an opening, including: a door body; and a guide mechanism configured to guide the door body in a sliding direction along the wall body. The guide mechanism guides the door body slidably between an open position where the door body opens the opening and a closed position where the door body closes the opening. A direction orthogonal to a wall surface of the wall body is a wall-orthogonal direction, a direction orthogonal to the sliding direction in a view in the wall-orthogonal direction is a width direction, a side from the closed position toward the open position in the sliding direction is a sliding direction first side, and a side on which the wall body is disposed relative to the door body in the wall-orthogonal direction is a wall-orthogonal direction first side. A portion of the door body that is disposed on the sliding direction first side relative to the opening in the open position and overlaps with the wall surface in a view in the wall-orthogonal direction is a door body overlapping portion. The door body has an elastic fire-resistant member attached thereto. The elastic fire-resistant member includes a fixing portion fixed to the door body overlapping portion and a contact portion formed in one piece with the fixing portion. The contact portion extends along the width direction of the door body overlapping portion and protrudes toward the wall-orthogonal direction first side relative to the door body. When the door body is in the closed position, the contact portion comes into contact with the wall body and closes a gap between the door body and the wall body in the wall-orthogonal direction. The contact portion slides against the wall body as the door body moves in the sliding direction.

According to this configuration, the contact portion of the elastic fire-resistant member slides against the wall body as the door body moves from the open position to the closed position. When the door body is in the closed position, the contact portion of the elastic fire-resistant member closes the gap between the door body and the wall body in the wall-orthogonal direction. In this way, the opening of the wall body can be closed while the fire-resistant member having elasticity (elastic fire-resistant member) is brought into close contact with the wall body. Accordingly, in the event of a fire, for example, the gap between the door body and the wall body can be closed with high reliability.

In this way, with this configuration, it is easy to improve the ability to close the opening.

Further features and advantages of the sliding fire door will become apparent from the following description of exemplary, non-limiting embodiments thereof, which are described with reference to the drawings.

### BRIEF DESCRIPTION OF THE DRAWINGS

FIG. 1 is a front view of a fire door with a door body in an open position.

FIG. 2 is a front view of the fire door with the door body in a closed position.

FIG. 3 is a plan view schematically showing a pressing mechanism.

FIG. 4 is a cross-sectional view schematically showing disposition of an elastic fire-resistant member.

FIG. 5 is a cross-sectional view schematically showing the elastic fire-resistant member sliding against a wall surface.

FIG. 6 is a cross-sectional view schematically showing arrangement of the elastic fire-resistant member and an intermediate member.

FIG. 7 is a plan view schematically showing contact between a leading end surface of the door body and an elastic member in the closed position.

### DESCRIPTION OF THE INVENTION

Hereinafter, an embodiment of a fire door will be described with reference to the drawings.

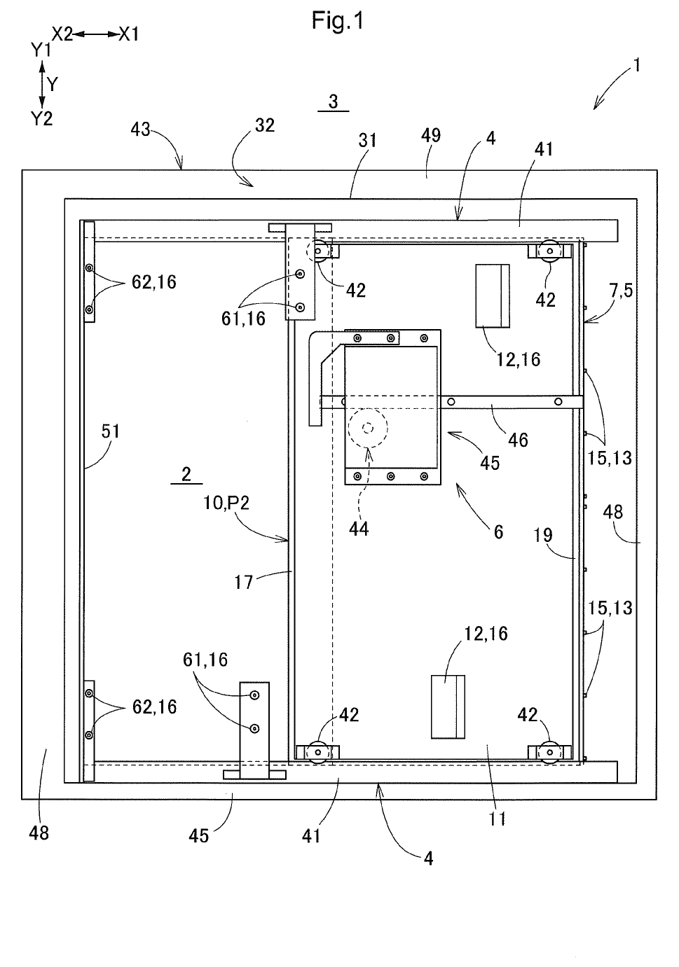

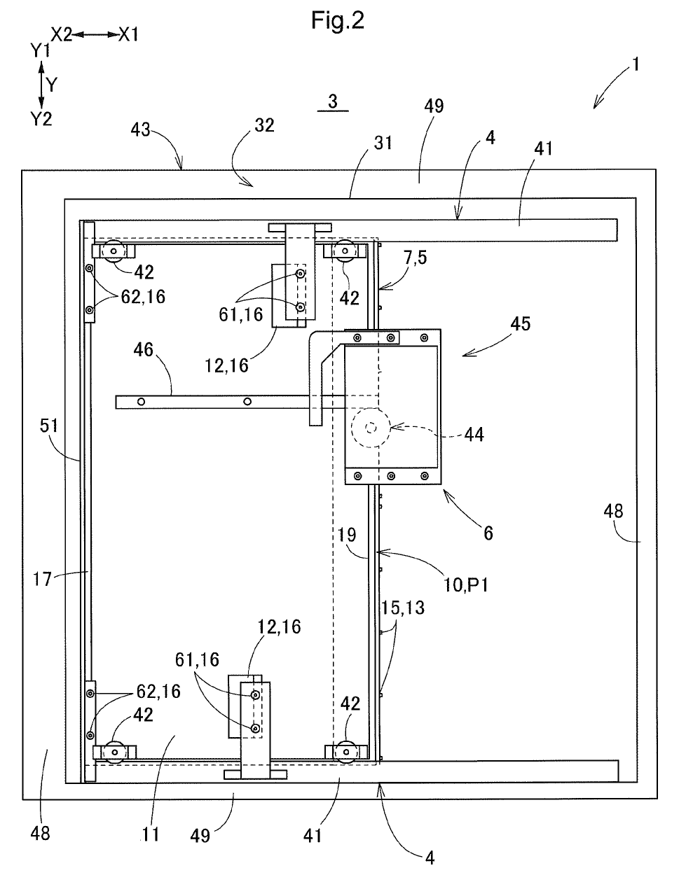

As shown in FIGS. 1 and 2, a fire door 1 is attached to a wall body 3 having an opening 2. In this example, the fire door 1 is used in an article transport facility. For example, a travel rail (not shown) on which a ceiling transport vehicle travels is disposed in the opening 2. The ceiling transport vehicle can pass through the opening 2 and travel between adjacent rooms. Note that the fire door 1 can be applied also to a facility other than an article transport facility. The opening 2 can also be formed in such a manner that a transport vehicle other than a ceiling transport vehicle (e.g., a trackless vehicle, a track-guided vehicle, etc.), a worker, and the like can travel therethrough.

The fire door 1 includes a door body 10 and guide mechanisms 4 that guide the door body 10 in a sliding direction X along the wall body 3. The guide mechanisms 4 guide the door body 10 slidably between an open position P2 where the door body 10 opens the opening 2 and a closed position P1 where the door body 10 closes the opening 2. Here, a direction orthogonal to a wall surface 32 of the wall body 3 is a wall-orthogonal direction Z, and a direction orthogonal to the sliding direction X in a view in the wall-orthogonal direction Z is denoted as a width direction Y. In addition, a side from the closed position P1 toward the open position P2 in the sliding direction X will be referred to as a sliding direction first side X1, and a side where the wall body 3 is arranged relative to the door body 10 in the wall-orthogonal direction Z will be referred to as a wall-orthogonal direction first side Z1. The side opposite to the wall-orthogonal direction first side Z1 is a wall-orthogonal direction second side Z2. One side in the width direction Y is a width direction first side Y1, and the opposite side is a width direction second side Y2. In this example, the width direction Y is a direction along the up-down direction. The width direction first side Y1 is the upper side in the up-down direction, and the width direction second side Y2 is the lower side in the up-down direction. The sliding direction X is a direction along the wall body 3 and along the horizontal plane. Here, “a direction along the horizontal plane” also includes a direction that is slightly inclined relative to the horizontal plane.

In this example, as shown in FIGS. 1 and 2, the wall body 3 includes a wall main body 34 and a wall plate 31 for attaching the fire door 1 to the wall main body 34. The wall plate 31 is a plate-shaped member (base plate) extending along the sliding direction X and the width direction Y. The wall plate 31 is fixed to the wall main body 34 at the attachment position of the fire door 1. Here, the wall plate 31 is fixed to the surface of the wall main body 34 opposing the wall-orthogonal direction second side Z2. The opening 2 passes through both the wall plate 31 and the wall main body 34 in the wall-orthogonal direction Z. In this example, the wall surface 32 of the wall body 3 is a surface opposing the wall-orthogonal direction second side Z2 of the wall plate 31 (the side on which the door body 10 is disposed). In FIGS. 1 and 2, the end of the opening 2 on the sliding direction first side X1 is indicated by a single-dot chain line.

As shown in FIGS. 1 and 2, the guide mechanisms 4 include guide wheels 42 and guide rails 41 that guide movement of the guide wheels 42 in the sliding direction X. In this example, the door body 10 is provided with a plurality of (in this example, four) guide wheels 42. More specifically, a plurality of guide wheels 42 are spaced apart from each other in the width direction Y (here, the up-down direction). A pair of guide rails 41 are spaced apart from each other in the width direction Y.

In this example, the fire door 1 includes an outer frame 43. The outer frame 43 includes a pair of vertical members 48 arranged along the width direction Y and spaced apart from each other in the sliding direction X, and a pair of horizontal members 49 arranged along the sliding direction X and spaced apart from each other in the width direction Y. The outer frame 43 is fixed to the wall plate 31 of the wall body 3. In the illustrated example, the pair of guide rails 41 are fixed to the wall plate 31. The guide rail 41 on the width direction second side Y2 is supported by the outer frame 43 (the horizontal member 49 on the width direction second side Y2). Note that the pair of guide rails 41 may also be fixed directly to the outer frame 43.

In this example, as shown in FIGS. 1 and 2, the door body 10 is arranged along the sliding direction X and the width direction Y. In addition, the door body 10 is supported by the guide mechanism 4. The door body 10 is provided with the above-mentioned plurality of guide wheels 42 spaced apart from each other in the width direction Y. The door body 10 is supported by the pair of guide rails 41 via the plurality of guide wheels 42. The door body 10 slides from the sliding direction first side X1 to the sliding direction second side X2, whereby the door body 10 is disposed in the closed position P1. In the closed position P1, the door body 10 covers the entire opening 2 in a view in the wall-orthogonal direction Z. In FIG. 1, the end of the door body 10 on the sliding direction first side X1 in the closed position P1 is indicated by a broken line. In addition, the door body 10 slides from the sliding direction second side X2 to the sliding direction first side X1, whereby the door body 10 is disposed in the open position P2. In the open position P2, the opening 2 is not covered by the door body 10 and is open.

In this example, as shown in FIGS. 1 and 2, the fire door 1 includes a drive mechanism 6 and a drive apparatus 45 that move the door body 10 along the sliding direction X. Here, the drive apparatus 45 is an electric motor. In the illustrated example, the drive mechanism 6 includes a rack 46 and a pinion 44 that meshes (engages) with the rack 46. The drive apparatus 45 rotates the pinion 44. The rack 46 is provided on the door body 10. The pinion 44 is supported by the drive apparatus 45.

A portion of the door body 10 that is on the sliding direction first side X1 relative to the opening 2 in the open position P2 and overlaps with the wall surface 32 in a view in the wall-orthogonal direction Z is a door body overlapping portion 11. In addition, a portion of the door body overlapping portion 11 that overlaps with the wall surface 32 in both the closed position P1 and the open position P2 is referred to as a door body rear end portion 19. The door body rear end portion 19 is an end region of the door body 10 on the sliding direction first side X1.

As shown in FIGS. 1, 2, 4, and 5, an elastic fire-resistant member 5 is attached to the door body 10. The elastic fire-resistant member 5 is a fire-resistant member having elasticity. In this example, the elastic fire-resistant member 5 is made of a material that expands to, for example, a volume several times to several tens of times larger when heated to a predetermined temperature or higher. Here, the elastic fire-resistant member 5 has a sheet shape at room temperature.

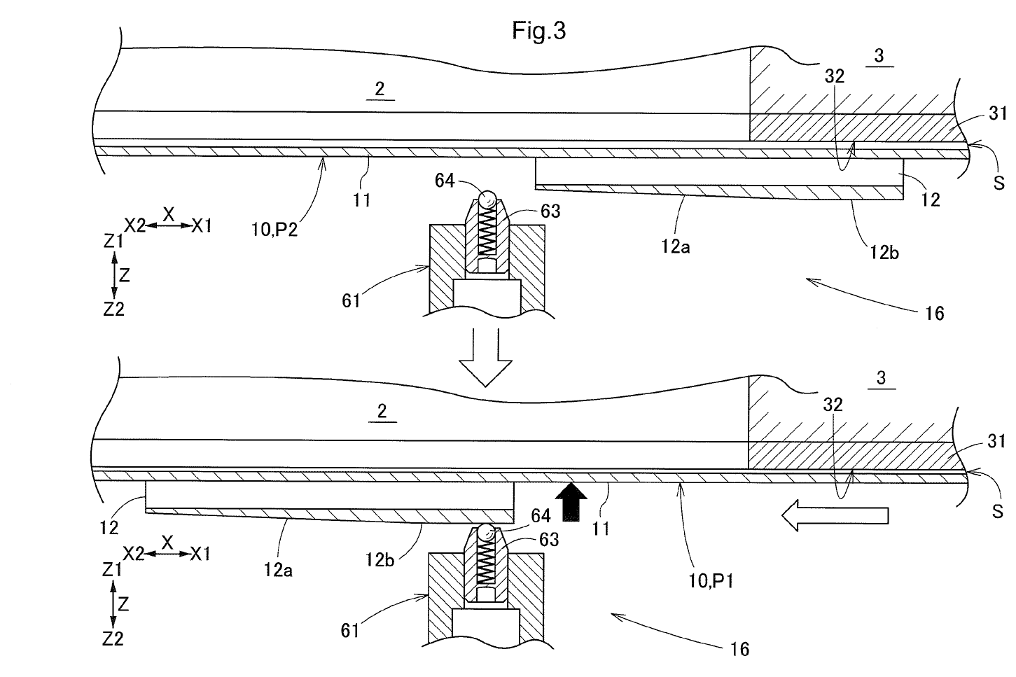

The elastic fire-resistant member 5 includes a fixing portion 7 fixed to the door body overlapping portion 11 and a contact portion 8 formed in one piece with the fixing portion 7. In this embodiment, the fixing portion 7 is fixed to the door body rear end portion 19. The contact portion 8 extends along the width direction Y of the door body overlapping portion 11 and protrudes toward the wall-orthogonal direction first side Z1 relative to the door body 10. The contact portion 8 is adjacent on the sliding direction first side X1 to a gap S and overlaps with the gap S in a view in the sliding direction X. When the door body 10 is in the closed position P1, the contact portion 8 comes into contact with the wall body 3 and closes the gap S between the door body 10 and the wall body 3 in the wall-orthogonal direction Z. In this embodiment, as shown in FIGS. 3 to 5, the gap S is formed between the door body 10 and the wall surface 32 in the wall-orthogonal direction Z. As shown in FIG. 5, the contact portion 8 comes into contact with the wall surface 32 when the door body 10 is in the closed position P1. As a result, the gap S is covered by the contact portion 8 from the sliding direction first side X1. In this way, the contact portion 8 closes the gap S from the sliding direction first side X1. Note that in this example, the contact portion 8 covers the entire region in the width direction Y of the gap S from the sliding direction first side X1 (FIG. 5). In this embodiment, a contact surface 8a of the contact portion 8 that comes into contact with the wall body 3 has a shape curved in such a manner as to protrude toward the wall-orthogonal direction first side Z1 in a view in the width direction Y. In this example, the shape of the contact surface 8a is curved over the entire region in the width direction Y of the contact portion 8.

In this embodiment, the elastic fire-resistant member 5 is attached with use of an attachment member 13 to an attachment surface 9 of the door body 10 facing the sliding direction first side X1. The attachment surface 9 is a surface of the door body 10 facing the sliding direction first side X1, or in other words, a surface of the door body rear end portion 19 facing the sliding direction first side X1. In the illustrated example, the door body rear end portion 19 includes an attachment portion 91 that corresponds to the attachment member 13. A plurality of attachment portions 91 are provided in correspondence with a plurality of attachment members 13 arranged side by side in the width direction Y. The attachment surface 9 is a surface of the attachment portion 91 facing the sliding direction first side X1. The fixing portion 7 of the elastic fire-resistant member 5 is disposed along the attachment surface 9 of the door body rear end portion 19. The fixing portion 7 is then fixed to the attachment surface 9 by the attachment member 13. Accordingly, the contact portion 8 protrudes toward the wall-orthogonal direction first side Z1 relative to the door body 10, at a position adjacent to the door body rear end portion 19.

In this example, the elastic fire-resistant member 5 has a U shape that is open to the wall-orthogonal direction second side Z2 in a view in the width direction Y. In this example, as described above, the elastic fire-resistant member 5 has a sheet shape. For this reason, when the elastic fire-resistant member 5 is attached to the attachment surface 9, the elastic fire-resistant member 5 is bent to be formed into a U shape in a view in the width direction Y. The elastic fire-resistant member 5 has a U shape that is open to the wall-orthogonal direction second side Z2 such that the contact portion 8 has a curved shape. For this reason, the fixing portion 7 is a portion of the U-shaped elastic fire-resistant member 5 that overlaps with the attachment surface 9 in a view in the sliding direction X, and is a portion other than the curved portion. Accordingly, in this example, the fixing portion 7 is a pair of strip-shaped portions (hereinafter referred to as a pair of strip-shaped portions 17) that spaced apart from each other in the sliding direction X. In this embodiment, the attachment member 13 is configured in such a manner that when the elastic fire-resistant member 5 is fixed to the attachment surface 9, the shapes of the contact portion 8 and the fixing portion 7 are not significantly deformed.

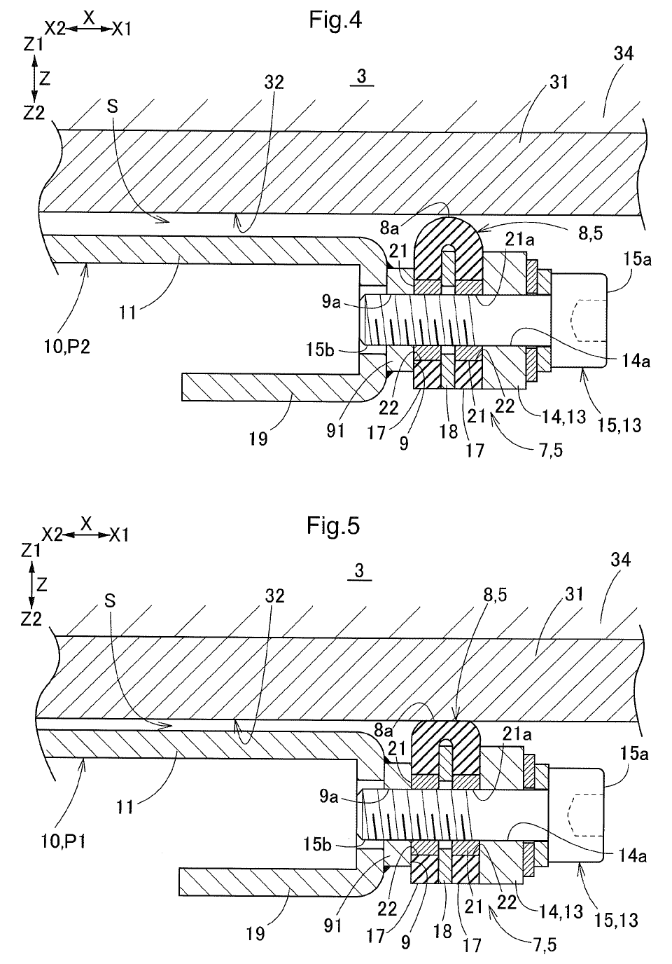

As shown in FIGS. 4 to 6, the fire door 1 of this embodiment further includes an intermediate member 18 extending along the wall-orthogonal direction Z and the width direction Y. The intermediate member 18 is made of a material harder than that of the elastic fire-resistant member 5. In this embodiment, the elastic fire-resistant member 5 surrounds the intermediate member 18 while covering the intermediate member 18 from at least the wall-orthogonal direction first side Z1. Here, “surrounding” is not limited to surrounding the entire periphery of the intermediate member 18 in a view in the width direction Y, for example, but also includes surrounding a part of the entire periphery. In this example, the elastic fire-resistant member 5 surrounds a part of the entire periphery of the intermediate member 18 while covering it from the wall-orthogonal direction first side Z1 in a view in the width direction Y. In the illustrated example, the elastic fire-resistant member 5 covers the intermediate member 18 from both sides in the sliding direction X and the wall-orthogonal direction first side Z1 in a view in the width direction Y. On the other hand, the elastic fire-resistant member 5 does not cover the intermediate member 18 from the wall-orthogonal direction second side Z2 in a view in the width direction Y. In this way, the elastic fire-resistant member 5 has a U shape in a view in the width direction Y. The intermediate member 18 is disposed inside the U shape formed by the elastic fire-resistant member 5, in such a manner as to extend along the wall-orthogonal direction Z and the width direction Y. In this example, the intermediate member 18 is a plate-shaped member extending in the wall-orthogonal direction Z and the width direction Y. The intermediate member 18 is disposed in such a manner as to abut against the surface of the fixing portion 7 facing the sliding direction X. Here, the intermediate member 18 is disposed between the pair of strip-shaped portions 17 (in the sliding direction X). This makes it easier to maintain the U shape even when the fixing portion 7 is fastened and fixed to the attachment surface 9 by the attachment member 13, for example. That is, it is possible to reduce the likelihood that the pair of strip-shaped portions 17 will abut against each other in the sliding direction X as in the case where the intermediate member 18 is not disposed, whereby a load under which the elastic fire-resistant member 5 bends more than necessary is applied, and as a result, the elastic fire-resistant member 5 is damaged. In this example, the elastic fire-resistant member 5 is disposed by being wrapped around the intermediate member 18.

As shown in FIGS. 4 to 6, the attachment member 13 includes a clamping member 14 and a fastening member 15. The clamping member 14 is made of a material harder than that of the elastic fire-resistant member 5. The clamping member 14 is disposed on the side opposite to the attachment surface 9 with the elastic fire-resistant member 5 and the intermediate member 18 interposed therebetween. The fastening member 15 fastens and fixes the elastic fire-resistant member 5, the intermediate member 18, and the clamping member 14 to the door body 10, with the elastic fire-resistant member 5 and the intermediate member 18 interposed between the attachment surface 9 and the clamping member 14. The clamping member 14 is disposed on the sliding direction first side X1 relative to the fixing portion 7 (here, the pair of strip-shaped portions 17), and overlaps with the entire region of the fixing portion 7 in the width direction Y in a view in the sliding direction X. The clamping member 14 is a member for restricting the movement of the elastic fire-resistant member 5 in the sliding direction X relative to the door body 10.

The fastening member 15 penetrates through the clamping member 14, the elastic fire-resistant member 5, and the intermediate member 18 in the sliding direction X. The fastening member 15 is a fastening bolt here. The fastening member 15 includes a fastening head 15a (here, a bolt head) and a fastening body 15b (here, a bolt body) that penetrates through the fixing portion 7. The fixing portion 7 of the elastic fire-resistant member 5 (i.e., the pair of strip-shaped portions 17) has a through hole 22 through which the fastening body 15b can be inserted in the sliding direction X. The attachment portion 91 also has an attachment hole 9a (here, a female screw hole) for inserting the fastening body 15b therethrough. Similarly, the clamping member 14 also has a clamping hole 14a through which the fastening body 15b is inserted. In this example, the fixing portion 7 is fastened and fixed to the attachment surface 9 by a plurality of fastening members 15 arranged in the width direction Y (FIGS. 1 and 2). Accordingly, the through holes 22, the attachment holes 9a, and the clamping holes 14a are formed in correspondence with the respective fastening members 15.

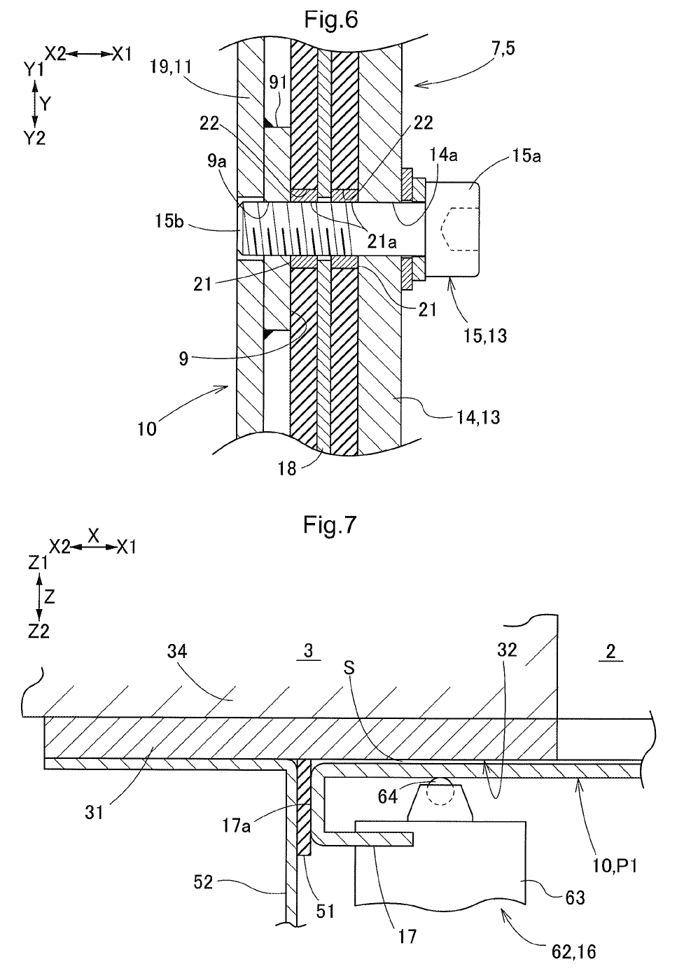

As shown in FIGS. 4 to 6, the elastic fire-resistant member 5 has spacers 21 having a thickness corresponding to the thickness of the elastic fire-resistant member 5, the spacers 21 being disposed around the through holes 22 through which the fastening member 15 penetrates. The spacers 21 are configured to support a load acting on the elastic fire-resistant member in the sliding direction X from the fastening member 15 between the clamping member 14 and the attachment surface 9. Specifically, the spacers 21 support a load in the sliding direction X from the fastening member 15 between the clamping member 14 and the attachment surface 9. In this example, a plurality of spacers 21 corresponding to the plurality of fastening members 15 are arranged. The dimension (thickness) of the spacers 21 in the sliding direction X corresponds to the thickness of the fixing portion 7. More specifically, the spacers 21 have a thickness corresponding to the dimension in the sliding direction X of the strip-shaped portions 17 of the fixing portion 7. In this example, the spacers 21 are disposed with the fastening body 15b inserted therethrough. Accordingly, the spacers 21 have spacer holes 21a for inserting the fastening body 15b therethrough. The through hole 22 formed in each of the pair of strip-shaped portions 17 is formed to a size that allows a spacer 21 to be disposed therein. The through hole 22 has a radial dimension that corresponds to that of the spacer 21. In the illustrated example, a spacer 21 is disposed in the through hole 22 of each of the pair of strip-shaped portions 17. That is, the pair of spacers 21 correspond to the pair of strip-shaped portions 17 (FIG. 6). The intermediate members 18 are not disposed in the regions in the width direction Y where the fastening bodies 15b and the spacers 21 are arranged (FIG. 6). The intermediate members 18 may have holes corresponding to the fastening bodies 15b and the spacers 21, or may be spaced apart from each other in the width direction Y so as not to interfere with these members.

With the elastic fire-resistant member 5, the intermediate member 18, the spacers 21, and the clamping member 14 arranged as described above, the fixing portion 7 is fastened and fixed between the clamping member 14 and the attachment surface 9 by the plurality of fastening members 15. As a result, the elastic fire-resistant member 5 is firmly fixed to the attachment surface 9 of the door body 10. For example, if the elastic fire-resistant member 5 is a member that expands significantly when heated, it is possible to restrict the expansion of the elastic fire-resistant member 5 (especially the fixing portion 7) in the sliding direction X while promoting its expansion in the wall-orthogonal direction Z, thereby enabling the gap S between the door body 10 and the wall body 3 in the wall-orthogonal direction Z to be closed with high reliability.

As shown in FIGS. 1 to 3, the fire door 1 includes a pressing mechanism 16 that presses the door body 10 toward the wall surface 32 (wall-orthogonal direction first side Z1). The pressing mechanism 16 includes first pressing portions 61 and second pressing portions 62 that press the door body 10, and a pressed portion 12 provided on the door body 10. Here, the first pressing portion 61 is configured to press the pressed portion 12. In the illustrated example, a plurality of first pressing portions 61 are spaced apart from each other in the width direction Y. In addition, as shown in FIG. 7, a plurality of second pressing portions 62 are spaced apart from each other in the width direction Y in such a manner as to press the leading end portion of the door body 10 (the end on the sliding direction second side X2). These pressing portions are supported by the guide rails 41. Each of the first pressing portions 61 and the second pressing portions 62 includes a pressing member 63 (here, a plunger). The door body 10 is pressed toward the wall body 3 by the pressing members 63.

As shown in FIG. 3, the pressed portion 12 has a flat surface 12b extending along the sliding direction X and the width direction Y, and an inclined surface 12a extending along the sliding direction X and the width direction Y and inclining toward the wall-orthogonal direction first side Z1 as it approaches the sliding direction second side X2. These surfaces are surfaces of the pressed portion 12 facing the wall-orthogonal direction second side Z2. The inclined surface 12a is formed continuously from the end of the flat surface 12b on the sliding direction second side X2. Here, the position of the leading end of a pin 64 (in the illustrated example, a sphere provided at the leading end of a spring) of the pressing member 63 in the wall-orthogonal direction Z is between a position of the end of the inclined surface 12a on the wall-orthogonal direction first side Z1 and a position of the flat surface 12b on the wall-orthogonal direction first side Z1.

Here, when the door body 10 slides from the open position P2 to the closed position P1, the pressed portion 12 approaches the pressing member 63 of the first pressing portion 61. Then, the pin 64 of the pressing member 63 abuts against the inclined surface 12a. As the door body 10 moves toward the sliding direction second side X2, the pin 64 moves relative to the inclined surface 12a to the sliding direction first side X1 (relative movement with respect to the pressed portion 12) and reaches the flat surface 12b. The first pressing portion 61 provided with the pressing member 63 is fixed to the guide rail 41 in such a manner that its position does not change. Accordingly, as the pin 64 moves on the inclined surface 12a to the sliding direction first side X1, the door body 10 is pressed toward the wall surface 32 by the pressing member 63. This reduces the interval of the gap S in the wall-orthogonal direction Z. When the door body 10 reaches the closed position P1, the pressing member 63 comes into contact with the flat surface 12b (FIG. 3). Note that in the illustrated example, no pressed portion 12 corresponding to the second pressing portions 62 is provided. In the second pressing portions 62, the door body 10 in the closed position P1 comes into direct contact with the pressing members 63 and is pressed toward the wall surface 32 by the pressing members 63. In the closed position P1, the door body 10 is pressed by the second pressing portions 62 in a region on the sliding direction second side X2 (more specifically, the end region on the sliding direction second side X2) relative to a central region in the sliding direction X. In addition, the door body 10 is pressed on both outer sides relative to the central region in the width direction Y by a plurality of (here, two) first pressing portions 61. Note that the positions where the pressing portions press the door body 10 can be changed as appropriate.

As shown in FIGS. 4 and 5, the contact portion 8 is configured to slide relative to the wall body 3 as the door body 10 moves in the sliding direction X. In this embodiment, the contact portion 8 slides on the wall surface 32 in a part of a region in the sliding direction X in which the door body 10 moves. In this example, as described above, when the first pressing portions 61 press against the pressed portions 12 as the door body 10 slides from the open position P2 to the closed position P1, the door body 10 approaches the wall surface 32 side. As a result, the contact portion 8 abuts against the wall surface 32. Then, the contact portion 8 moves toward the sliding direction first side X1 while sliding against the wall surface 32 until the door body 10 reaches the closed position P1, that is, until the first pressing portions 61 press against the inclined surfaces 12a and then press against the flat surfaces 12b. When the first pressing portions 61 press against the flat surface 12b (when the door body 10 reaches the closed position P1), the interval of the gap S in the wall-orthogonal direction Z becomes the smallest. The contact portion 8 of the elastic fire-resistant member 5 having elasticity comes into contact with the wall surface 32 with its curved shape being pressed from the wall-orthogonal direction second side Z2 (FIG. 5).

As shown in FIG. 7, the fire door 1 further includes an elastic member 51 that abuts against the door end (the end on the sliding direction second side X2) of the door body 10 when in the closed position P1. In the illustrated example, the elastic member 51 is provided on a support member 52 that supports the elastic member 51. Here, the support member 52 is fixed to the wall plate 31. In this example, the elastic member 51 has a sheet shape that extends along the wall-orthogonal direction Z and the width direction Y, and is disposed in such a manner as to abut against the entire region in the width direction Y of the door end surface 17a, which is the surface of the door body 10 facing the sliding direction second side X2. In this example, the elastic member 51 is a fire-resistant member having the same elasticity as the elastic fire-resistant member 5. Note that in the illustrated example, the elastic member 51 is not bent, unlike the elastic fire-resistant member 5 attached to the attachment surface 9.

### Other Embodiments

(1) In the above embodiment, a configuration was described as an example in which the sliding direction X is a direction extending along the horizontal plane. However, there is no limitation to this. The sliding direction X may also be, for example, a direction along the up-down direction, or may be a direction inclined relative to the up-down direction.

(2) In the above embodiment, a configuration was described as an example in which the contact surface 8a of the contact portion 8 that comes into contact with the wall body 3 has a shape curved in such a manner as to protrude toward the wall-orthogonal direction first side Z1 in a view in the width direction Y. However, there is no limitation to this. The contact surface 8a may also have a shape curved in such a manner as to protrude toward the wall-orthogonal direction first side Z1 in a view in the width direction Y, or may have a linear shape in a view in the width direction Y.

(3) In the above embodiment, a configuration was described as an example in which the elastic fire-resistant member 5 is disposed in such a manner as to form a U shape that is open to the wall-orthogonal direction second side Z2 in a view in the width direction Y. However, there is no limitation to this. The elastic fire-resistant member 5 does not need to be disposed in such a manner as to form a U shape as described above. In a case where the elastic fire-resistant member 5 has a sufficient thickness or the like, the elastic fire-resistant member 5 may be disposed as-is without being formed into a U shape. In such a disposition, the intermediate member 18 need not be included.

(4) In the above embodiment, a configuration was described as an example in which the attachment member 13 includes a clamping member 14 made of a material harder than that of the elastic fire-resistant member 5. However, there is no limitation to this. The attachment member 13 does not necessarily need to include the clamping member 14. For example, if the elastic fire-resistant member 5 is not a member that expands several times to several tens of times when heated, the clamping member 14 does not necessarily need to be included.

(5) In the above embodiment, a configuration was described as an example in which the spacer 21 having a thickness corresponding to the thickness of the elastic fire-resistant member 5 is disposed around the through hole 22 in the elastic fire-resistant member 5 through which the fastening member 15 penetrates. However, there is no limitation to this. Such a spacer 21 may also be disposed at a location other than around the through hole 22.

(6) Note that the configurations disclosed in the above-described embodiments can be applied in combination with configurations disclosed in other embodiments, as long as no contradiction occurs. Regarding other configurations, the embodiments disclosed in this specification are merely examples in all respects. Accordingly, various modifications can be made as appropriate without departing from the spirit of the present disclosure.

### Summary of Above Embodiment

The following is a summary of the sliding fire door described above.

The sliding fire door according to the present disclosure is a sliding fire door to be attached to a wall body having an opening, including: a door body; and a guide mechanism configured to guide the door body in a sliding direction along the wall body. The guide mechanism guides the door body slidably between an open position where the door body opens the opening and a closed position where the door body closes the opening. A direction orthogonal to a wall surface of the wall body is a wall-orthogonal direction, a direction orthogonal to the sliding direction in a view in the wall-orthogonal direction is a width direction, a side from the closed position toward the open position in the sliding direction is a sliding direction first side, and a side on which the wall body is disposed relative to the door body in the wall-orthogonal direction is a wall-orthogonal direction first side. A portion of the door body that is disposed on the sliding direction first side relative to the opening in the open position and overlaps with the wall surface in a view in the wall-orthogonal direction is a door body overlapping portion. The door body has an elastic fire-resistant member attached thereto. The elastic fire-resistant member includes a fixing portion fixed to the door body overlapping portion and a contact portion formed in one piece with the fixing portion. The contact portion extends along the width direction of the door body overlapping portion and protrudes toward the wall-orthogonal direction first side relative to the door body. When the door body is in the closed position, the contact portion comes into contact with the wall body and closes a gap between the door body and the wall body in the wall-orthogonal direction. The contact portion slides against the wall body as the door body moves in the sliding direction.

According to this configuration, the contact portion of the elastic fire-resistant member slides against the wall body as the door body moves from the open position to the closed position. When the door body is in the closed position, the contact portion of the elastic fire-resistant member closes the gap between the door body and the wall body in the wall-orthogonal direction. In this way, the opening of the wall body can be closed while the fire-resistant member having elasticity (elastic fire-resistant member) is brought into close contact with the wall body. Accordingly, in the event of a fire, for example, the gap between the door body and the wall body can be closed with high reliability.

In this way, with this configuration, it is easy to improve the ability to close the opening.

Here, in the configuration in which the contact portion slides against the wall body as the door body moves in the sliding direction, it is preferable that the contact surface of the contact portion that comes into contact with the wall body has a shape curved in such a manner as to protrude toward the wall-orthogonal direction first side in a view in the width direction.

According to this configuration, the contact surface of the elastic fire-resistant member that comes into contact with the wall surface has a curved shape that bulges out toward the wall surface in a view in the width direction. This makes it easier to suppress the contact portion of the fire-resistant member sliding on the wall surface from getting caught on the wall surface. Accordingly, the contact portion allows the wall body to slide smoothly, and the gap between the door body and the wall body can be closed with high reliability when in the closed position.

In addition, it is preferable to further include an intermediate member extending along the wall-orthogonal direction and the width direction, in which the elastic fire-resistant member surrounds the intermediate member while covering the intermediate member from at least the wall-orthogonal direction first side.

According to this configuration, due to the intermediate member being surrounded by the elastic fire-resistant member, it is possible to easily maintain a suitable shape of the elastic fire-resistant member in a view in the width direction.

In addition, in a configuration in which the contact portion slides against the wall body as the door body moves in the sliding direction, it is preferable that the elastic fire-resistant member is attached with use of an attachment member to an attachment surface of the door body facing the sliding direction first side, the attachment member includes a clamping member and a fastening member, the clamping member is disposed on a side opposite to the attachment surface with the elastic fire-resistant member and the intermediate member interposed therebetween, and the fastening member fastens and fixes the elastic fire-resistant member, the intermediate member, and the clamping member to the door body with the elastic fire-resistant member and the intermediate member interposed between the attachment surface and the clamping member.

According to this configuration, the clamping member is disposed on the side opposite to the attachment surface with the elastic fire-resistant member and the intermediate member interposed therebetween, and these members are fastened and fixed to the door body while being clamped by the fastening member. Accordingly, when the contact portion of the elastic fire-resistant member slides against the wall body, the elastic fire-resistant member can be restricted from deforming or vibrating more than necessary in the sliding direction, making it easier to smooth the sliding movement of the sliding fire door. In addition, for example, in the event of a fire, the elastic fire-resistant member can be restricted from pushing the clamping member due to thermal expansion or the like and moving the clamping member toward the sliding direction first side relative to the door body.

In addition, it is preferable that the elastic fire-resistant member is attached with use of a fastening member to an attachment surface of the door body facing the sliding direction first side, the fastening member penetrates through the elastic fire-resistant member and the intermediate member in the sliding direction, the elastic fire-resistant member has a through hole through which the fastening member penetrates, and has a spacer having a thickness corresponding to a thickness of the elastic fire-resistant member, the spacer being disposed around the through hole, and the spacer is configured to support a load acting on the elastic fire-resistant member from the fastening member in the sliding direction.

According to this configuration, the spacer corresponding to the thickness (dimension in the sliding direction) of the elastic fire-resistant member supports the load in the sliding direction from the fastening member acting on the elastic fire-resistant member. Therefore, it is possible to prevent the elastic fire-resistant member from significantly deforming in the sliding direction due to the load.

The sliding fire door according to the present disclosure need only have at least one of the above-mentioned effects.

What is claimed is:

1. A sliding fire door to be attached to a wall body having an opening, comprising:
a door body; and
a guide mechanism configured to guide the door body in a sliding direction along the wall body, and
wherein:
the guide mechanism guides the door body slidably between an open position where the door body opens the opening and a closed position where the door body closes the opening,
a direction orthogonal to a wall surface of the wall body is a wall-orthogonal direction, a direction orthogonal to the sliding direction in a view in the wall-orthogonal direction is a width direction, a side from the closed position toward the open position in the sliding direction is a sliding direction first side, and a side on which the wall body is disposed relative to the door body in the wall-orthogonal direction is a wall-orthogonal direction first side,
a portion of the door body that is disposed on the sliding direction first side relative to the opening in the open position and overlaps with the wall surface in a view in the wall-orthogonal direction is a door body overlapping portion,
the door body has an elastic fire-resistant member attached thereto,
the elastic fire-resistant member comprises a fixing portion fixed to the door body overlapping portion and a contact portion formed in one piece with the fixing portion,
the contact portion extends along the width direction of the door body overlapping portion and protrudes toward the wall-orthogonal direction first side relative to the door body,
when the door body is in the closed position, the contact portion comes into contact with the wall body and closes a gap between the door body and the wall body in the wall-orthogonal direction, and
the contact portion slides against the wall body as the door body moves in the sliding direction.

2. The sliding fire door according to claim 1,
wherein the contact surface of the contact portion that comes into contact with the wall body has a shape curved in such a manner as to protrude toward the wall-orthogonal direction first side in a view in the width direction.

3. The sliding fire door according to claim 1, further comprising:
an intermediate member extending along the wall-orthogonal direction and the width direction, and
wherein the elastic fire-resistant member surrounds the intermediate member while covering the intermediate member from at least the wall-orthogonal direction first side.

4. The sliding fire door according to claim 3, wherein:
the elastic fire-resistant member is attached with use of an attachment member to an attachment surface of the door body facing the sliding direction first side,
the attachment member comprises a clamping member and a fastening member,
the clamping member is disposed on a side opposite to the attachment surface with the elastic fire-resistant member and the intermediate member interposed therebetween, and
the fastening member fastens and fixes the elastic fire-resistant member, the intermediate member, and the clamping member to the door body with the elastic fire-resistant member and the intermediate member interposed between the attachment surface and the clamping member.

5. The sliding fire door according to claim 3, wherein:
the elastic fire-resistant member is attached with use of a fastening member to an attachment surface of the door body facing the sliding direction first side,
the fastening member penetrates through the elastic fire-resistant member and the intermediate member in the sliding direction,
the elastic fire-resistant member has a through hole through which the fastening member penetrates, and has a spacer having a thickness corresponding to a thickness of the elastic fire-resistant member, the spacer being disposed around the through hole, and
the spacer is configured to support a load acting on the elastic fire-resistant member from the fastening member in the sliding direction.
